(19) United States
(12) Patent Application Publication
(10) Pub. No.: US 2005/0141641 A1
(43) Pub. Date: Jun. 30, 2005

(54) Receiving method and receiving apparatus with adaptive array signal processing

(75) Inventors: Yasuhiro Tanaka, Ichinomiya-shi (JP); Seigo Nakao, Gifu-shi (JP); Yoshiharu Doi, Gifu-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/016,807

(22) Filed: Dec. 21, 2004

(30) Foreign Application Priority Data
Dec. 26, 2003 (JP) 2003-432120

(51) Int. Cl. H04K 1/10

(52) U.S. Cl. 375/316

(57) ABSTRACT

A correlation unit calculates a correlation value from a digital received signal and a predetermined signal. A receiving weight calculation unit applies the LMS algorithm so as to calculate a receiving weight vector signal. The application of the algorithm is based on a spread signal when the digital received signal is adapted for the spectrum spreading scheme, and based on a time-domain signal when the digital received signal is adapted for the OFDM modulation scheme. A multiplication unit weights the digital received signal by the receiving weight vector signal, and an addition unit adds outputs from individual units of the multiplication unit. An FFT unit calculates a fast Fourier transform of a synthesized signal and outputs a frequency-domain signal. A despreading unit despreads the synthesized signal and outputs a despread signal.

### BACKGROUND OF THE INVENTION

1. Field of the Invention

The present invention generally relates to a receiving technology and, more particularly, to a receiving method and receiving apparatus in which signals received by a plurality of antennas are subject to adaptive array signal processing.

2. Description of the Related Art

In wireless communication, effective use of frequency resources, which are generally limited, is sought. One of the technologies available for effective use of frequency resources is an adaptive array antenna technology. In the adaptive array antenna technology, the amplitude and phase of signals transmitted and received by a plurality of antennas are controlled so that a directivity pattern of the antennas is formed. More specifically, in an apparatus provided with an adaptive array antenna, the amplitude and phase of signals received by a plurality of antennas are altered. The plurality of received signals thus altered are added to each other. The signal, to be received by the antennas of a directivity pattern according to the degree of alteration (hereinafter, referred to as “weight”) of the amplitude and phase, is received. Transmission of a signal is performed in a directivity pattern according to the weight.

In the adaptive array antenna technology, the weight may be calculated using, for example, a method based on the minimum mean square error (MMSE) method. In the MMSE method, a Wiener solution is known as a condition to give the most appropriate value of weight. Also, a recurrence formula requiring a smaller volume of calculation than determining the Weiner solution directly is known. For example, the recursive least squares (RLS) algorithm or the least mean square (LMS) algorithm are used as recurrence formulas.

For the purpose of increasing the data transmission rate and improving the transmission quality, data may be modulated using multiple carriers so that the resultant multicarrier signal is transmitted. When the multicarrier signal is applied to the adaptive array technology, it is necessary to calculate a weight corresponding to the multicarrier signal. A general practice for this purpose is to convert a received time-domain multicarrier signal into a frequency-domain multicarrier signal, which is then subject to a necessary process (See Reference (1) in the following Related Art List, for instance).

Related Art List

(1) Japanese Patent Application Laid-Open No. Hei10-210099.

When the adaptive algorithm is performed on the frequency-domain multicarrier signal and the weight is calculated for each subcarrier included in the multicarrier signal, the processing volume is increased as the number of subcarriers is increased. When the received signal may be a signal other than the multicarrier signal, i.e. when the received signal may be, for example, a spectrum spread signal, the adaptive algorithm process methods used should be switched from one to another so that both signals are properly processed. In circuit implementation, switching between adaptive algorithm process methods affects operation timings and handling of reference signals in relation to the frequency-domain signal and other signals. Therefore, there may be needed an extra circuit.

### SUMMARY OF THE INVENTION

The present invention has been done in view of the aforementioned circumstances and its object is to provide a method and apparatus of receiving a multicarrier signal or a signal other than the multicarrier signal by a plurality of antennas and subjecting the received signal to adaptive array signal processing.

One mode of practicing the present invention is a receiver apparatus. The receiver apparatus comprises: an input unit receiving a plurality of signals; a calculating unit calculating a plurality of weight coefficients from the input plurality of signals; a synthesizing unit weighting the input plurality of signals with the plurality of weight coefficients calculated, and synthesizing the weighted signals; a determining unit determining whether the input plurality of signals are multicarrier signals or non-multicarrier signals; a first-demodulating unit performing demodulation by converting the synthesized signal from a time domain into a frequency domain, when the input plurality of signals are multicarrier signals; a second demodulating unit demodulating the synthesized signal, when the input plurality of signals are non-multicarrier signals. The calculating unit in this apparatus may calculate the plurality of weight coefficients, based on a time-domain multicarrier signal, when the input plurality of signals are multicarrier signals.

According to the aforementioned apparatus, a multicarrier signal is processed in a time domain for calculation of a plurality of weight coefficients, in a similar configuration as a non-multicarrier signal. Accordingly, an adaptive array process is executed regardless of whether the input signals are multicarrier signals or non-multicarrier signals.

Signals determined by said determining unit as being non-multicarrier signals may be spectrum spread signals, said calculating unit may store a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and said second demodulating unit may demodulate the synthesized signal by despreading.

The apparatus may further comprise a control unit designating, for demodulation, a switch from the second demodulating unit to the first demodulating unit for a demodulation process, when the input plurality of signals change from non-multicarrier signals to multicarrier signals. The apparatus may further comprise a control unit designating, for demodulation, a switch from the first demodulating unit to the second demodulating unit for a demodulation process, when the input plurality of signals change from multicarrier signals to non-multicarrier signals.

Another mode of practicing the present invention is a receiving method. The method calculates a plurality of weight coefficients from an input plurality of signals, weights the input plurality of signals with the plurality of weight coefficients calculated, and synthesizes resultant signals, wherein the input plurality of signals are processed based on a time-domain signal, and the plurality of weight coefficients are calculated, regardless of whether the input plurality of signals are multicarrier signals or not.

Still another mode of practicing the present invention is a receiving method. The method comprises: receiving a plurality of signals; calculating a plurality of weight coefficients from the input plurality of signals; weighting the input plurality of signals with the plurality of weight coefficients calculated, and synthesizing the weighted signals; determining whether the input plurality of signals are multicarrier signals or non-multicarrier signals; performing demodulation by converting the synthesized signal from a time domain into a frequency domain, when the input plurality of signals are multi carrier signals; demodulating the synthesized signal, when the input plurality of signals are non-multicarrier signals. The calculating in this method may be based on a time-domain multicarrier signal, when the input plurality of signals are multicarrier signals.

Non-multicarrier signals determined as such in the determining may be spectrum spread signals, the calculating may store a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and the demodulating may demodulate the synthesized signal by despreading.

The receiving method may further comprise designating, for demodulation, a switch from the demodulating of the synthesized signal to the performing of demodulation by converting the synthesized signal from a time domain into a frequency domain, when the input plurality of signals change from non-multicarrier signals to multicarrier signals. The receiving method may further designating, for demodulation, a switch from the performing of demodulation by converting the synthesized signal from a time domain into a frequency domain to the demodulating of the synthesized signal, when the input plurality of signals change from multicarrier signals to non-multicarrier signals.

Yet another mode of practicing the present invention is a program. This program, executable by a computer, includes the functions of: receiving a plurality of signals via a wireless network; calculating a plurality of weight coefficients from the input plurality of signals and storing the weight coefficients in a memory; weighting the input plurality of signals with the plurality of weight coefficients stored in the memory, and synthesizing the weighted signals; determining whether the input plurality of signals are multicarrier signals or non-multicarrier signals; performing demodulation by converting the synthesized signal from a time domain into a frequency domain, when the input plurality of signals are multicarrier signals; demodulating the synthesized signal, when the input plurality of signals are non-multicarrier signals. The calculating in this program may be based on a time-domain multicarrier signal, when the input plurality of signals are multicarrier signals.

Non-multicarrier signals determined as such in the determining may be spectrum spread signals, the calculating and storing may store a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and the demodulating may demodulate the synthesized signal by despreading.

It is to be noted that any arbitrary combination of the above-described structural components and expressions changed among a method, an apparatus, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of a communications system according to an example of the present invention.

FIG. 2 shows one of burst formats according to the example.

FIG. 3 shows another burst format according to the example.

FIG. 4 shows yet another burst format according to the example.

FIG. 5 shows a structure of a first radio unit of FIG. 1.

FIG. 6 shows a structure of a signal processing unit and a modem unit of FIG. 1.

FIG. 7 shows a structure of a receiving weight vector calculating unit.

FIG. 8 is a flowchart showing a procedure of a demodulation process in a signal processing unit and a modem unit.

### DETAILED DESCRIPTION OF THE INVENTION

The invention will now be described based on the following examples which do not intend to limit the scope of the present invention but exemplify the invention. All of the features and the combinations thereof described in the examples are not necessarily essential to the invention.

Before describing the present invention in detail, a summary of will be given. An example of the present invention relates to a base station apparatus performing an adaptive array signal process on a plurality of signals received by a plurality of antennas. The type of base station apparatus assumed as a target of application is a base station apparatus for wireless local area network (LAN). The wireless LAN processed in the base station apparatus are based on a system complying with IEEE802.11a, a system complying with IEEE802.11b and a system complying with IEEE02.11g. In other words, the base station apparatus is capable of using both 2.4 GHz and 5 GHz as a radio frequency. Both the spectrum spreading scheme and the orthogonal frequency division multiplexing (OFDM) scheme may be used as a secondary modulation scheme in a baseband.

A radio frequency for the base station apparatus is set up externally by, for example, a switch. That is, one of 2.4 GHz and 5 GHz is selected for communication. When the apparatus is set up for 5 GHz, the OFDM modulation scheme is used as a secondary modulation scheme. When the apparatus is set up for 2.4 GHz, one of the spectrum spreading scheme and the OFDM modulation scheme is used. In the base station apparatus according to this example, an adaptive algorithm is applied to signals in an adaptive array signal process in order to estimate a receiving weight vector. A training signal in an adaptive algorithm is stored as a time-domain signal even when the OFDM modulation scheme is employed. In the case of spectrum spreading communication, a spread spectrum signal is stored. That is, the adaptive algorithm is applied to a signal subjected to secondary modulation. For this reason, application of the adaptive algorithm according to this example does not depend on whether the secondary modulation is the spectrum spreading scheme or the OFDM modulation scheme. Further, after the training, the same adaptive algorithm process is applied only by changing the value of a determination signal which is to be referred to.

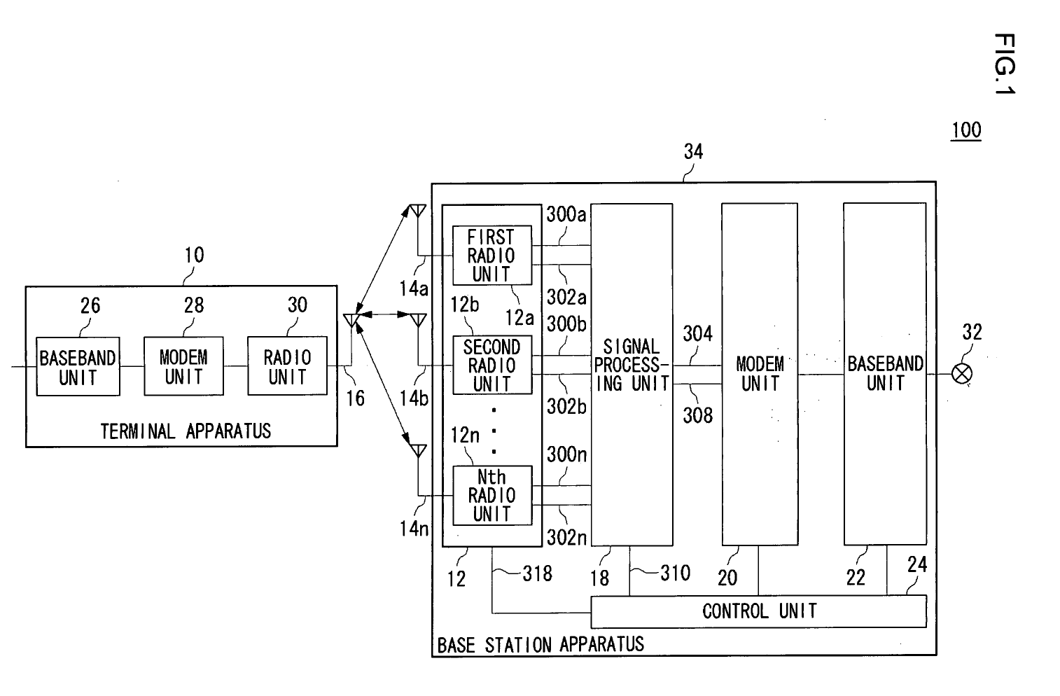

FIG. 1 shows a structure of a communications system 100 according to this example. The communications system 100 includes a terminal apparatus 10, a base station apparatus 34 and a network 32. The terminal apparatus 10 includes a baseband unit 26, a modem unit 28, a radio unit 30 and a terminal antenna 16. The base station apparatus 34 includes a first base station antenna 14a, a second base station antenna 14b, an Nth base station antenna 14n, generically referred to as a base station antenna 14, a first radio unit 12a, a second radio unit 12b, an Nth radio unit 12n, generically referred to as a radio unit 12, a signal processing unit 18, a modem unit 20, a baseband unit 22 and a control unit 24. The terminal apparatus 10 involves a first digital received signal 300a, a second digital received signal 300b, an Nth digital received signal 300n, generically referred to as a digital received signal 300, a first digital transmission-signal 302a, a second digital transmission signal 302b, an Nth digital transmission signal 302n, generically referred to as a digital transmission signal 302, a synthesized signal 304, a pre-separation signal 308, a signal processing unit control signal 310, a radio unit control signal 318 and a modem control signal 332.

The baseband unit 22 of the base station apparatus 34 is an interface with the network 32. The baseband unit 26 of the terminal apparatus 10 is an interface for a PC connected to the terminal apparatus 10 or an application in the terminal apparatus 10. The baseband units 22 and 26 are responsible for transmission and receiving, respectively, of information signals for transmission by communications system 100. Error correction or automatic retransmission process may be included. However, a description of these is omitted.

The modem unit 20 of the base station apparatus 34 and the modem unit 28 of the terminal apparatus 10 generate a signal for transmission by modulating a carrier with an information signal and demodulates the received signal so as to reproduce the information signal. The modem unit 20 includes a spreading unit and a despreading unit adapted for the spectrum spreading scheme, and also includes an inverse fast Fourier transform (IFFT) unit and a fast Fourier transform (FFT) unit for the OFDM modulation scheme.

The signal processing unit 18 performs signal processing necessary for transmission and receiving by the adaptive array antennas. The radio unit 12 of the base station apparatus 34 and the radio unit 30 of the terminal apparatus 10 perform a frequency conversion processes between a baseband signal and a radio signal. The baseband signal is processed by the signal processing unit 18, the modem unit 20, the baseband unit 22, the baseband unit 26 and the modem unit 28. The radio unit also performs an amplitude process, and an AD or DA conversion process. Since it is assumed that the communications system 100 is adapted for wireless LAN according to IEEE802.11a, IEEE802.11b and IEEE802.11g, the radio unit 12 is adapted for the radio frequency of 2.4 GHz and 5 GHz. The value of radio frequency is set by a user using a switch (not shown).

The base station antenna 14 of the base station apparatus 34 and the terminal antenna 16 of the terminal apparatus 10 transmit and receive radio frequency signals. The directivity of the antennas may be as desired. It is assumed that a total of N antennas constitute the base station antenna 14.

The control unit 24 controls the timing of the radio unit 12, the signal processing unit 18, the modem unit 20 and the baseband unit 22. The control unit 24 controls the channel allocation.

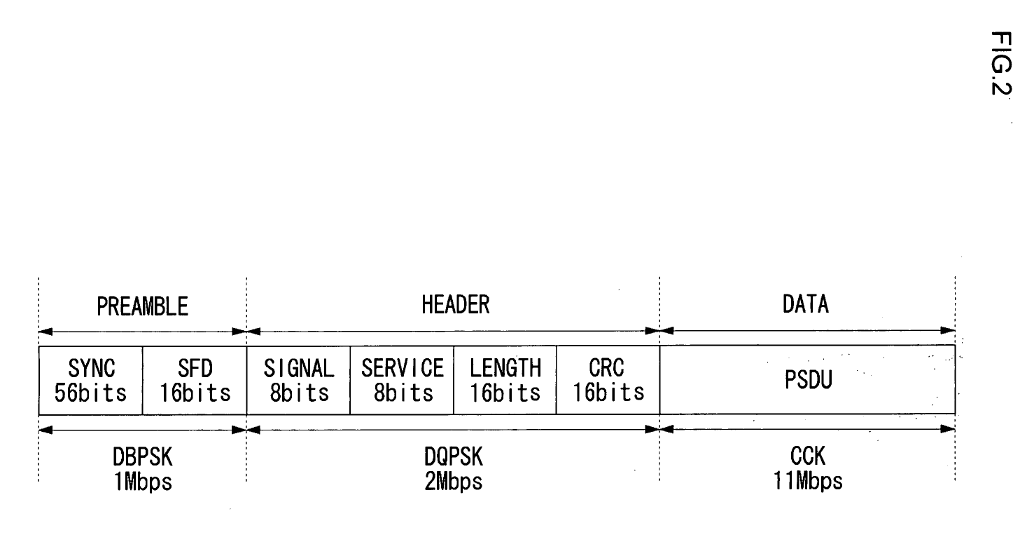

FIG. 2 shows one of burst formats according to the example. The burst format shown corresponds to Short PLCP of the IEEE802.11b standard. As shown, a burst signal includes a preamble, a header and data, which are spectrum spread. The preamble is transmitted at a transmission rate of 1 Mbps according to the DBPSK modulation scheme. The header is transmitted at a transmission rate of 2 Mbps according to the DQPSK modulation scheme. The data are transmitted at 11 Mbps according to the CCK modulation scheme. The preamble includes a 56-bit SYNC and a 16-bit SFD. The header includes an 8-bit SIGNAL, an 8-bit SERVICE, a 16-bit LENGTH and a 16-bit CRC. The length of PSDU, corresponding to the data, is variable.

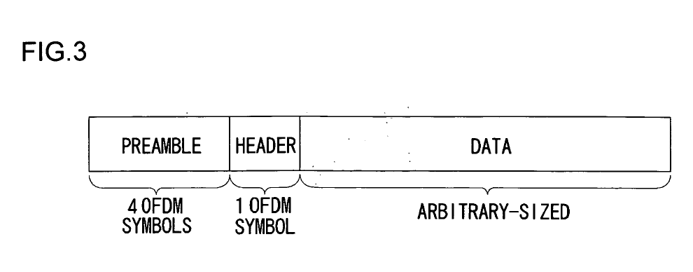

FIG. 3 shows another burst format according to the example. The burst format corresponds to the speech channel of the IEEE802.11a standard. In the burst signal, the OFDM modulation scheme is used. In the OFDM modulation scheme, the size of Fourier transform and the number of symbols in a guard interval combined constitute a unit. The unit in this example will be defined as an OFDM symbol. A preamble, primarily used for timing synchronization and carrier recovery, occupies four OFDM symbols at the head of the burst. As in FIG. 2, the header and the data are provided subsequent to the preamble. The format of FIG. 2 is also used in the IEEE802.11g. This format is referred to as a OFDM format.

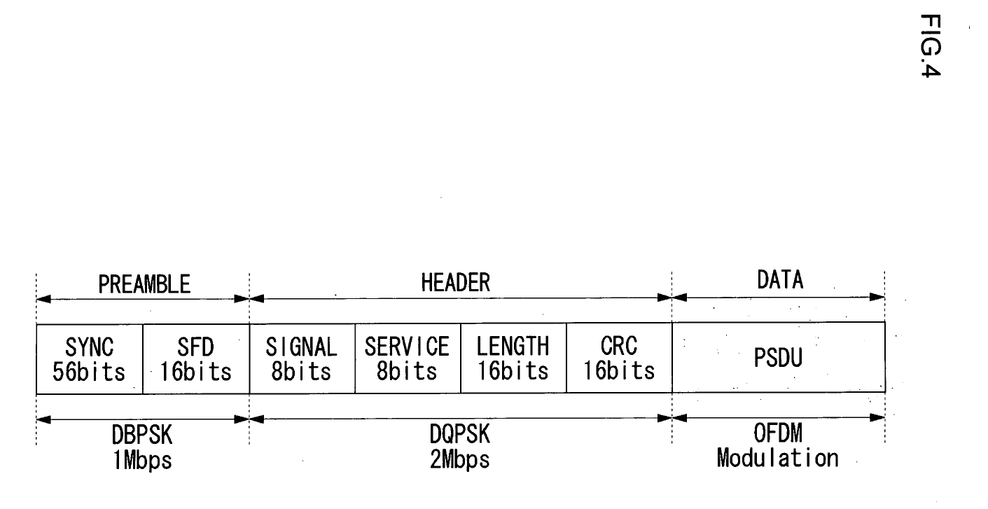

FIG. 4 shows yet another burst format according to the example. This burst format corresponds to Short Preamble PDU format of the IEEE802.11g standard. Like the burst signal of FIG. 2, the burst signal of FIG. 4 includes a preamble, a header and data. The preamble and the header are spectrum spread. The preamble is transmitted at a transmission rate of 1 Mbps by the DBPSK modulation scheme. The header is transmitted at a transmission rate of 2 Mbps by the DQPSK modulation scheme. The data are OFDM modulated. This format will be referred to as a mixed format in contrast to the OFDM format described before.

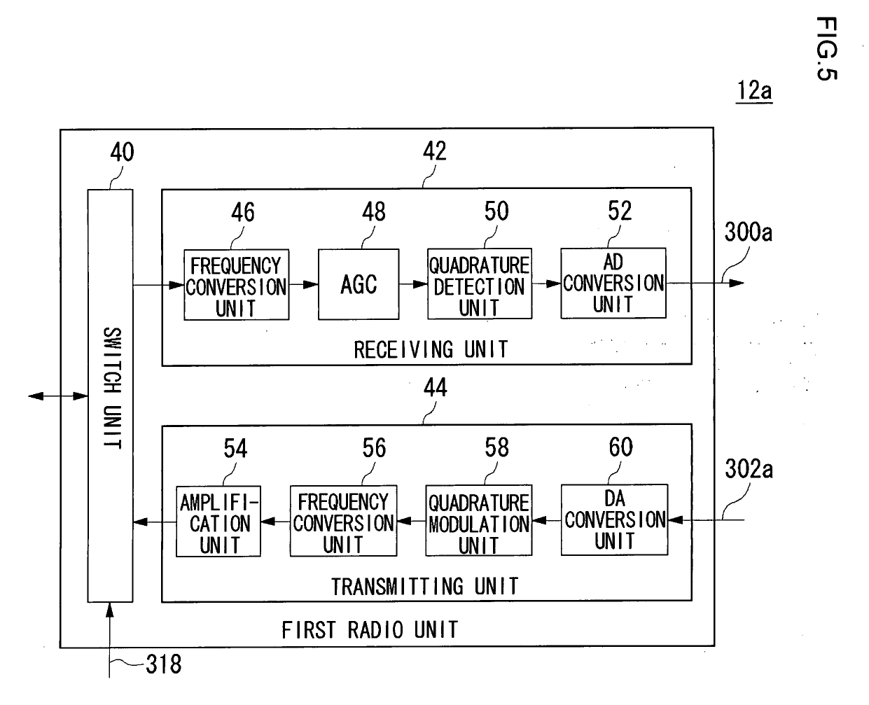

FIG. 5 shows a structure of the first radio unit 12a. The first radio unit 12a includes a switch unit 40, a receiving unit 42 and a transmission unit 44. The receiving unit 42 includes a frequency conversion unit 46, a automatic gain control (AGC) 48, a quadrature detection unit 50 and an AD conversion unit 52. The transmission unit 44 includes an amplification unit 54, a frequency conversion unit 56, a quadrature modulation unit 58 and a DA conversion unit 60.

The switch unit 40 switches between the receiving unit 42 and the transmission unit 44 for signal input and output, in accordance with a radio unit control signal 318. More specifically, the switch unit 40 selects a signal from the transmission unit 44 for transmission and selects a signal to the receiving unit 42 for receiving.

The frequency conversion unit 46 of the receiving unit 42 and the frequency conversion unit 56 of the transmission unit 44 subject a target signal to frequency conversion between a radio frequency of one of 5 GHz and 2.4 GHz, and an intermediate frequency. As mentioned before, selection of 5 GHz or 2.4 GHz is done by a user using a switch (not shown).

The AGC 48 automatically controls the gain so as to fit the amplitude of the received signal within a dynamic range of the AD conversion unit 52.

The quadrature detection unit 50 generates a baseband analog signal by subjecting the signal at the intermediate frequency to quadrature detection. The quadrature modulation unit 58 subjects the baseband analog signal to quadrature modulation and generates a signal at the intermediate frequency.

The AD conversion unit 52 converts the baseband analog signal into a digital signal, and the DA conversion unit 60 converts the baseband digital signal to an analog signal.

The amplification unit 54 amplifies the radio frequency signal for transmission.

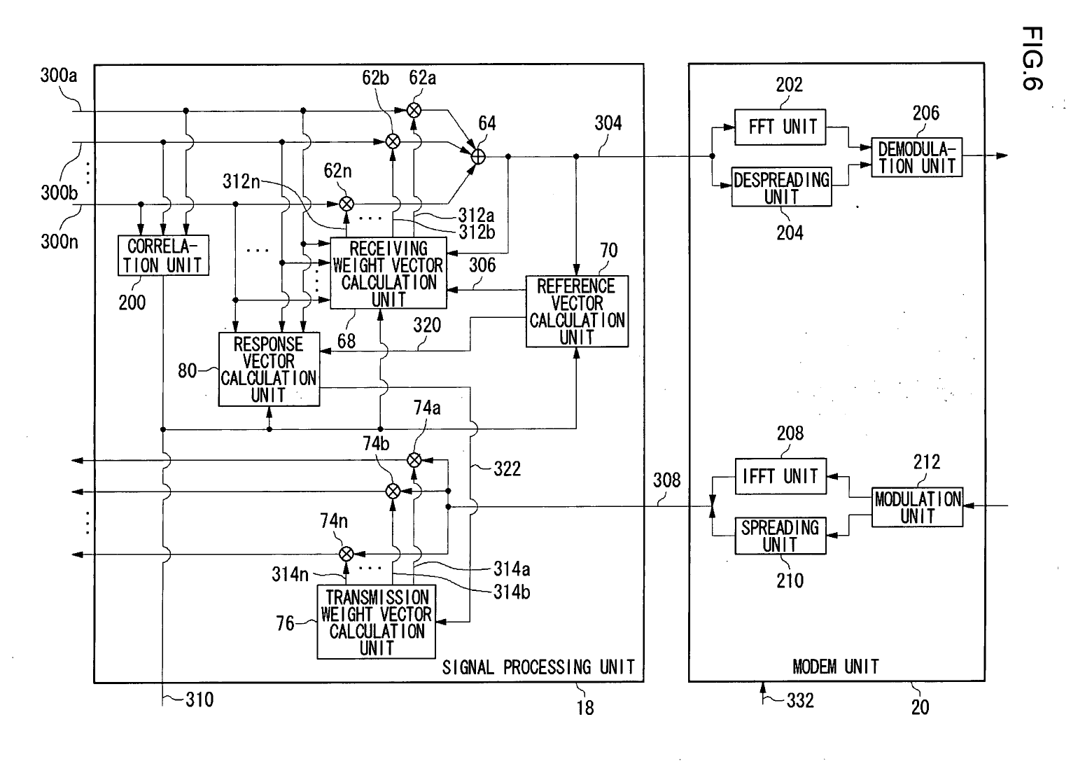

FIG. 6 shows a structure of the signal processing unit 18 and the modem unit 20. The signal processing unit 18 includes a first multiplication unit 62a, a second multiplication unit 62b, an Nth multiplication unit 62n, generically referred to as a multiplication unit 62, an addition unit 64, a receiving weight vector calculation unit 68, a reference signal generation unit 70, a first multiplication unit 74a, a second multiplication unit 74b, an Nth multiplication unit 74n, generically referred to as a multiplication unit 74, a transmission weight vector calculation unit 76, a response vector calculation unit 80 and a correlation unit 200. The modem unit 20 includes an FFT unit 202, a despreading unit 204, a demodulation unit 206, an IFFT unit 208, a spreading unit 210 and a modulation unit 212. Signals involved are a weight reference signal 306, a first receiving weight vector signal 312a, a second receiving weight vector signal 312b, an Nth receiving weight vector signal 312n, generically referred to as a receiving weight vector signal 312, a first transmission weight vector signal 314a, a second transmission weight vector signal 314b, an Nth transmission weight vector signal 314n, generically referred to as a transmission weight vector signal 314, a response reference signal 320 and a response vector signal 322.

The correlation unit 200 calculates a correlation value from the digital received signal 300 and a predetermined signal. At least two signals are stored as predetermined signals. One of the predetermined signals is a pattern in which the entirety or a part of the preamble or the header of FIGS. 2 and 4 are spectrum spread (hereinafter, such a pattern is referred to as a first pattern). The other predetermined signals is a pattern in which the entirety or a part of the preamble or the header of FIG. 3 is translated into a time domain (hereinafter, such a pattern is referred to as a second pattern). When the frequency of the radio frequency signal received by the base station antenna 14 is 2.4 GHz, a correlation with the first pattern is higher than the other pattern, if the digital received signal 300 is an IEEE802.11b burst or of a mixed format according to IEEE802.11g. If the signal 300 is of an OFDM format according to IEEE802.11g, a correlation with the second pattern is higher than the other pattern. The system with which the received signal conforms is identified as described above. The identity of the system is output to the control unit 24 as the signal processing unit control signal 310.

The receiving weight vector calculation unit 68 calculates, from the digital received signal 300, the synthesized signal 304 and the weight reference signal 306, the receiving weight vector signal 312 necessary to weight the digital received signal 300, by the LMS algorithm. When the digital received signal 300 complies with the spectrum spreading scheme, the LMS algorithm is applied based on the spectrum spread signal. When the digital received signal 300 complies with the OFDM modulation scheme, the LMS algorithm is applied based on the time-domain signal. If the digital received signal 300 is of a mixed format defined in IEEE802.11g, the signal processing unit control signal 310 switches from the LMS algorithm process based on the spectrum spread signal to the LMS algorithm process based on the time-domain signal. A algorithm switch of a reverse pattern may be effected depending on the format of burst.

The multiplication unit 62 weights the digital received signal 300 by the receiving weight signal 312, and the addition unit 64 adds the outputs of the multiplication unit 62 so as to output the synthesized signal 304.

The reference signal generation unit 70 outputs a pre-stored training signal as the weight reference signal 306 and the response reference signal 320 during a training period. If the digital received signal 300 is an IEEE802.11b burst or of a mixed format of IEEE802.11b and IEEE802.11g, the spectrum spread preamble signal of FIG. 2 or FIG. 4 is stored as the training signal. If the digital received signal is of the OFDM format of IEEE802.11g, the time-domain preamble signal of FIG. 3 is stored as the training signal. After the training period, the synthesized signal 304 is compared with a pre-defined threshold value for decision. The result of decision is output as the weight reference signal 306 and the response reference signal 320. The decision may not necessarily be hard decision and may be soft decision.

The response vector calculation unit 80 calculates the response vector signal 322 indicating the receiving response characteristic defined as the characteristic of a received signal with respect to a transmitted signal, from the digital received signal 300 and the response reference signal 320. The method of calculating the response vector signal 322 may be optional. For example, the response vector signal 322 may be calculated based on a correlating process. The digital received signal 300 and the response reference signal 320 may be input not only from the signal processing unit 18 but also from a signal processing unit corresponding to a terminal apparatus of a different user via a signal line (not shown). Indicating the digital received signal 300 corresponding to a first terminal apparatus by x1(t), the digital received signal 300 corresponding to a second terminal apparatus by x2(t), the response reference signal 320 corresponding to the first terminal apparatus by S1(t), and the response reference signal 320 corresponding to the second terminal apparatus by S2(t), x1(t) and x2(t) are given by the following equations.
x₁(t)=h₁₁S₁(t)+h₂₁S₂(t)
x₂(t)=h₁₂S₁(t)+h₂₂S₂(t) (1)
where hij indicates a response characteristic that occurs between an ith terminal apparatus and a jth base station antenna 14j. Noise is neglected. A first correlation matrix R1 is given by the following equation, where E indicates an ensemble average.

$${R}_{1} = [ \begin{matrix}E [ {x}_{1} {S}_{1}^{*} ] & E [ {x}_{2} {S}_{1}^{*} ] \\ E [ {x}_{1} {S}_{2}^{*} ] & E [ {x}_{2} {S}_{2}^{*} ]\end{matrix} ] \qquad ( 2 )$$

A correlation matrix R2 between the response reference signals 320 is calculated by the following equation.

$${R}_{2} = [ \begin{matrix}E [ {S}_{1} {S}_{1}^{*} ] & E [ {S}_{1}^{*} {S}_{2} ] \\ E [ {S}_{2} {S}_{1}^{*} ] & E [ {S}_{2}^{*} {S}_{2} ]\end{matrix} ] \qquad ( 3 )$$

Finally, an inverse matrix of the second correlation matrix R2 and the first correlation matrix R1 are multiplied, and the response vector signal 322 given by the following equation is obtained.

$$[ \begin{matrix}{h}_{11} & {h}_{12} \\ {h}_{21} & {h}_{22}\end{matrix} ] = {R}_{1} {R}_{2}^{- 1} \qquad ( 4 )$$

The transmission weight vector calculation unit 76 estimates the transmission weight vector signal 314 necessary to weight the pre-separation signal 308, from the receiving vector signal 312 and the response vector signal 322 indicating the receiving response characteristic. The method for estimating the transmission vector signal 314 maybe as desired. The simplest method may be to use the receiving weight vector signal 312 and the response vector signal 322 as they are. Alternatively, the receiving weight vector signal 312 and the response vector signal 322 may be corrected by the related-art technology in consideration of Doppler frequency variation occurring in the propagation environment between the timing of the receiving process and the timing of the transmission process. It is assumed here that the response vector signal 322 is used as the transmission weight vector signal 314.

The FFT unit 202 calculates a fast Fourier transform of the synthesized signal 304 and outputs a frequency-domain signal. The despreading unit 204 despreads the synthesized signal 304 and outputs a despread signal. In the case of mixed format of IEEE802.11g, the modem unit control signal 332 switches from the process in the despreading unit 204 to the process in the FFT unit 202. Switching may occur in a reverse pattern depending on the format of burst. The demodulation unit 206 demodulates the signal output from the FFT unit 202 or the despreading unit 204.

The modulation unit 212 modulates information for transmission. The IFFT unit 208 calculates an inverse Fourier transform of the modulated information so as to output a time-domain signal. The spreading unit 210 spreads the modulated information so as to output the spread signal. The time-domain signal output from the IFFT unit 208 and the spread signal output from the spreading unit 210 are indicated as pre-separation signal 308.

The multiplication unit 74 weights the pre-separation signal 308 by the transmission weight vector signal 314 so as to output the digital transmission signal 302. The aforementioned operation is timed in accordance with the signal processing unit control signal 310.

In terms of hardware the above-described structure can be realized by a CPU, a memory and other LSIs of an arbitrary computer. In terms of software, it is realized by memory-loaded programs which have a reserved management function or the like, but drawn and described herein are function blocks that are realized in cooperation with those. Thus, it is understood by those skilled in the art that these function blocks can be realized in a variety of forms such as by hardware only, software only or the combination thereof.

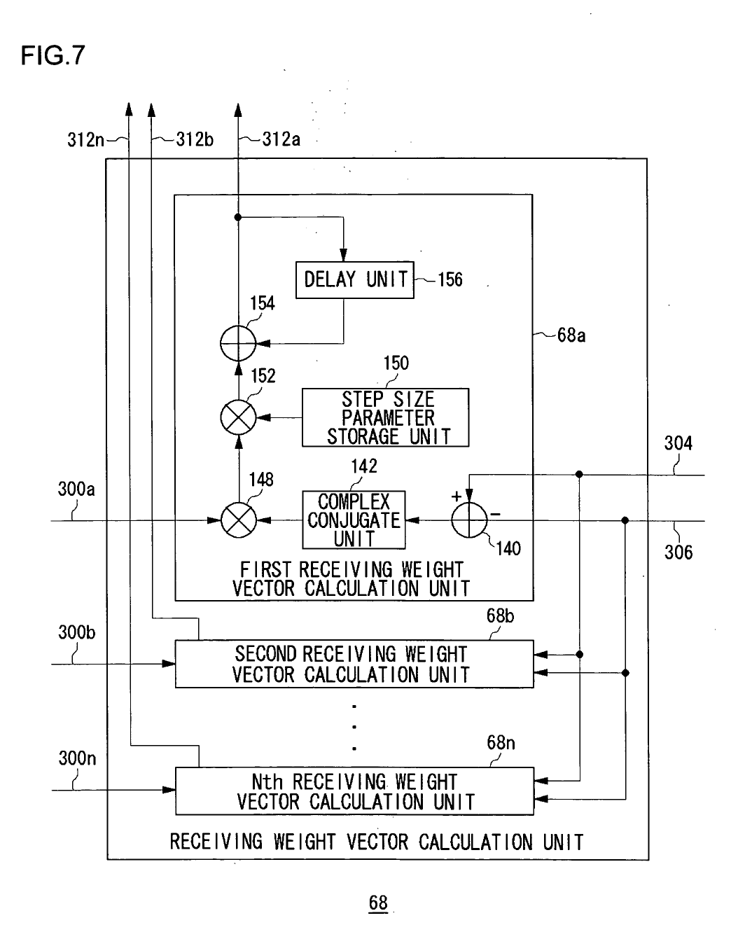

FIG. 7 shows a structure of the receiving weight vector calculation unit 68. The receiving weight vector calculation unit 68 is a generic reference to a first receiving weight vector calculation unit 68a, a second receiving weight vector calculation unit 68b and an Nth receiving weight vector calculation unit 68n. The receiving weight vector calculation unit 68 includes an addition unit 140, a complex conjugate unit 142, a multiplication unit 148, a step size parameter storage unit 150, a multiplication unit 152, an addition unit 154 and a delay unit 156.

The addition unit 140 calculates a difference between the synthesized signal 304 and the weight reference signal 306 so as to output an error signal, i.e., an error vector. The error signal is subject to complex conjugate transformation by the complex conjugate unit 142.

The multiplication unit 148 multiplies the error signal subjected to complex conjugate transformation with the first digital received signal 300a so as to generate a first multiplication result.

The multiplication unit 152 multiplies the first multiplication result with a step size parameter stored in the step size parameter storage unit 150 so as to generate a second multiplication result. The second multiplication result is fed back by the delay unit 156 and the addition unit 154 and added to the new second multiplication result. The addition result updated one after another by the LMS algorithm is output as the receiving weight vector signal 312. While the digital received signal 300 may be spectrum spread or OFDM modulated in the above-described structure, the only difference is the value of the weight reference signal 306, the other aspects of the structure being the same in both cases.

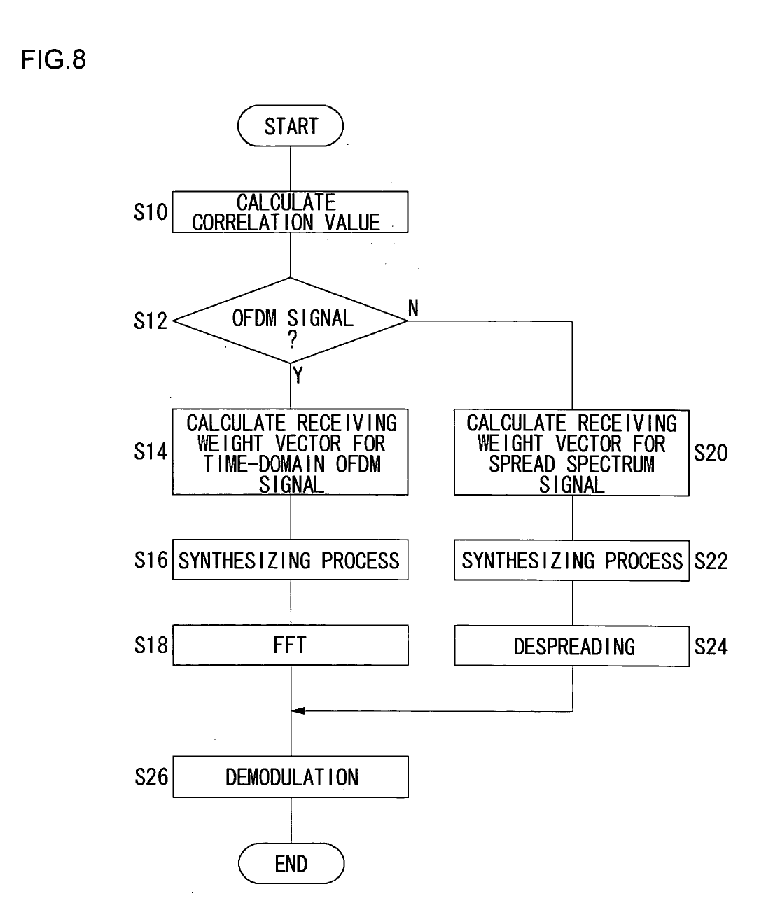

FIG. 8 is a flowchart showing a procedure of the demodulation process in the signal processing unit 18 and the modem unit 20. The correlation unit 200 calculates a correlation value from the digital received signal 300 (S10). If it is determined from the correlation value that the received signal is an OFDM signal (Y in S12), the receiving weight vector calculation unit 68 calculates the receiving weight vector signal 312 for the digital received signal 300, which is the OFDM signal in the time domain (S14). The multiplication unit 62 and the addition unit 64 subjects the digital received signal 300 to a synthesis process based on the receiving weight vector signal 312 so as to output the synthesized signal 304 (S16). The FFT unit 202 calculates a fast Fourier transform of the synthesized signal 304 (S18). If it is determined from the correlation value that the received signal is not an OFDM signal (N in S12), the receiving weight vector calculation unit 68 calculates the receiving weight vector signal 312 for the digital received signal 300, which is the spectrum spread signal (S20). The multiplication unit 62 and the addition unit 64 subjects the digital received signal 300 to a synthesis process based on the receiving weight vector signal 312 so as to output the synthesized signal 304 (S22). The despreading unit 204 despreads the synthesized signal 304 (S24). The demodulation unit 206 demodulates the output signal from the FFT unit 202 or the despreading unit 204 (S26).

Since the adaptive algorithm is executed in a time domain according to the example of the present invention, a signal other than a multicarrier signal is processed only by switching between reference signals. More specifically, the spectrum spread signal is processed properly. Operations to process the multicarrier signal and spectrum spread signal are nearly identical in timing. Therefore, the circuit is implemented merely by a simple correction. An increase in the number of sub-carriers only produces a small increase in the processing volume.

The present invention has been described based on the examples which are only exemplary. It is understood by those skilled in the art that there exist other various modifications to the combination of each component and process described above and that such modifications are encompassed by the scope of the present invention.

In the example of the present invention, the radio frequency used in the radio unit 12 is switched from one to the other using a switch (not shown) so that the circuit is set up for only one radio frequency. Alternatively, a plurality of radio units 12 adapted for respective radio frequencies may be provided so that the circuit may be used for the radio frequencies of 5 GHz and 2.4 GHz at the same time. In this case, the wireless LAN standard is identified based on the radio frequency detected by the radio unit 12 and the correlation value determined by the correlation unit 200. According to this variation, the invention may be adapted for a plurality of wireless LAN standards regardless of the radio frequency. A single receiving weight vector calculation unit 68 may be applied to the plurality of wireless LAN standards by changing the reference signal.

In this example of the present invention, the correlation unit 200 discriminates between 1) the burst of IEEE802.11b or the mixed format of IEEE802.11g, and 2) the OFDM format of IEEE802.11g, based on the correlation value. Alternatively, the correlation unit 200 may only be adapted for the burst of IEEE802.11b or the mixed format of IEEE802.11g. That is, the correlation unit 200 may only be adapted for a case in which the head of a burst is spectrum spread. According to this variation, the process is simplified. This variation serves the purpose of configuring a single receiving weight vector calculation unit 68 to be adapted for a plurality of wireless LAN standards.

Although the present invention has been described by way of exemplary embodiments and modified examples as above, it should be understood that many changes and substitutions may still further be made by those skilled in the art without departing from the scope of the present invention which is defined by the appended claims.

1. A receiver apparatus comprising:
an input unit receiving a plurality of signals;
a calculating unit calculating a plurality of weight coefficients from the input plurality of signals;
a synthesizing unit weighting the input plurality of signals with the plurality of weight coefficients calculated, and synthesizing the weighted signals;
a determining unit determining whether the input plurality of signals are multicarrier signals or non-multicarrier signals;
a first demodulating unit performing demodulation by converting the synthesized signal from a time domain into a frequency domain, when the input plurality of signals are multicarrier signals;
a second demodulating unit demodulating the synthesized signal, when the input plurality of signals are non-multicarrier signals, wherein
said calculating unit calculates the plurality of weight coefficients, based on a time-domain multicarrier signal, when the input plurality of signals are multicarrier signals.

2. The receiver apparatus according to claim 1, wherein
signals determined by said determining unit as being non-multicarrier signals are spectrum spread signals,
said calculating unit stores a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and
said second demodulating unit demodulates the synthesized signal by despreading.

3. The receiver apparatus according to claim 1, further comprising:
a control unit designating, for demodulation, a switch from the second demodulating unit to the first demodulating unit for a demodulation process, when the input plurality of signals change from non-multicarrier signals to multicarrier signals.

4. The receiver apparatus according to claim 2, further comprising:
a control unit designating, for demodulation, a switch from the second demodulating unit to the first demodulating unit for a demodulation process, when the input plurality of signals change from non-multicarrier signals to multicarrier signals.

5. The receiver apparatus according to claim 1, further comprising:
a control unit designating, for demodulation, a switch from the first demodulating unit to the second demodulating unit for a demodulation process, when the input plurality of signals change from multicarrier signals to non-multicarrier signals.

6. The receiver apparatus according to claim 2, further comprising:
a control unit designating, for demodulation, a switch from the first demodulating unit to the second demodulating unit for a demodulation process, when the input plurality of signals change from multicarrier signals to non-multicarrier signals.

7. A receiving method which calculates a plurality of weight coefficients from an input plurality of signals, weights the input plurality of signals with the plurality of weight coefficients calculated, and synthesizes resultant signals, wherein the input plurality of signals are processed based on a time-domain signal, and the plurality of weight coefficients are calculated, regardless of whether the input plurality of signals are multicarrier signals or not.

8. A receiving method comprising:
receiving a plurality of signals;
calculating a plurality of weight coefficients from the input plurality of signals;
weighting the input plurality of signals with the plurality of weight coefficients calculated, and synthesizing the weighted signals;
determining whether the input plurality of signals are multicarrier signals or non-multicarrier signals;
performing demodulation by converting the synthesized signal from a time domain into a frequency domain, when the input plurality of signals are multicarrier signals;
demodulating the synthesized signal, when the input plurality of signals are non-multicarrier signals, wherein
the calculating is based on a time-domain multicarrier signal, when the input plurality of signals are multicarrier signals.

9. The receiving method according to claim 8, wherein
non-multicarrier signals determined as such in the determining are spectrum spread signals,
the calculating stores a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and
the demodulating demodulates the synthesized signal by despreading.

10. The receiving method according to claim 8, further comprising designating, for demodulation, a switch from the demodulating of the synthesized signal to the performing of demodulation by converting the synthesized signal from a time domain into a frequency domain, when the input plurality of signals change from non-multicarrier signals to multicarrier signals.

11. The receiving method according to claim 9, further comprising designating, for demodulation, a switch from the demodulating of the synthesized signal to the performing of demodulation by converting the synthesized signal from a time domain into a frequency domain, when the input plurality of signals change from non-multicarrier signals to multicarrier signals.

12. The receiving method according to claim 8, further comprising designating, for demodulation, a switch from the performing of demodulation by converting the synthesized signal from a time domain into a frequency domain to the demodulating of the synthesized signal, when the input plurality of signals change from multicarrier signals to non-multicarrier signals.

13. The receiving method according to claim 9, further comprising designating, for demodulation, a switch from the performing of demodulation by converting the synthesized signal from a time domain into a frequency domain to the demodulating of the synthesized signal, when the input plurality of signals change from multicarrier signals to non-multicarrier signals.

14. A program executable by a computer, the program including the functions of:
receiving a plurality of signals via a wireless network;
calculating a plurality of weight coefficients from the input plurality of signals and storing the weight coefficients in a memory;
weighting the input plurality of signals with the plurality of weight coefficients stored in the memory, and synthesizing the weighted signals;
determining whether the input plurality of signals are multicarrier signals or non-multicarrier signals;
performing demodulation by converting the synthesized signal from a time domain into a frequency domain, when the input plurality of signals are multicarrier signals;
demodulating the synthesized signal, when the input plurality of signals are non-multicarrier signals, wherein
the calculating is based on a time-domain multicarrier signal, when the input plurality of signals are multicarrier signals.

15. The program according to claim 14, wherein non-multicarrier signals determined as such in the determining are spectrum spread signals,
the calculating and storing stores a time-domain multicarrier signal as a training signal to be used in adaptive algorithm for calculating the plurality of weight coefficients when the input plurality of signals are multicarrier signals, and also stores a spectrum spread signal to be used when the input plurality of signals are non-multicarrier signals, and
the demodulating demodulates the synthesized signal by despreading.

16. The program according to claim 14, further comprising designating, for demodulation, a switch from the demodulating of the synthesized signal to the performing of demodulation by converting the synthesized signal from a time domain into a frequency domain, when the input plurality of signals change from non-multicarrier signals to multicarrier signals.

17. The program according to claim 15, further comprising designating, for demodulation, a switch from the demodulating of the synthesized signal to the performing of demodulation by converting the synthesized signal from a time domain into a frequency domain, when the input plurality of signals change from non-multicarrier signals to multicarrier signals.

18. The program according to claim 14, further comprising designating, for demodulation, a switch from the performing of demodulation by converting the synthesized signal from a time domain into a frequency domain to the demodulating of the synthesized signal, when the input plurality of signals change from multicarrier signals to non-multicarrier signals.

19. The program according to claim 15, further comprising designating, for demodulation, a switch from the performing of demodulation by converting the synthesized signal from a time domain into a frequency domain to the demodulating of the synthesized signal, when the input plurality of signals change from multicarrier signals to non-multicarrier signals.
